(19) United States
(12) Patent Application Publication
(10) Pub. No.: US 2015/0135122 A1
(43) Pub. Date: May 14, 2015

(54) Assignment of multiple letters, characters, numbers, strokes and symbols to an individual key on a virtual/soft keyboard displayed on a viewing screen of an electronic device

(71) Applicants: Gary Streuter, Laguna Niguel, CA (US); William Pat Price, Henderson, NV (US)

(72) Inventors: Gary Streuter, Laguna Niguel, CA (US); William Pat Price, Henderson, NV (US)

(21) Appl. No.: 14/478,462

(22) Filed: Sep. 5, 2014

Related U.S. Application Data
(60) Provisional application No. 61/904,069, filed on Nov. 14, 2013.

(51) Int. Cl. G06F 3/0488

(52) U.S. Cl. CPC G06F 3/04886
USPC 715/773

(57) ABSTRACT

A system for use on a hand held computing device where a virtual/soft keyboard is presented on a display screen and where selected individual keys displayed within said virtual/soft keyboard have the ability to display any of a plurality of data characters assigned to each of said individual keys and select and insert into a designated data input area on said display screen where each said data character is displayed for a portion of a time duration of a user's continuous touch or press on said individual key and comprising:
a. a display screen on said hand held computing device,
b. a first software program that displays said virtual/soft keyboard on the display screen of said hand held computing device whereby,
c. said first software program assigns to each said individual key on said virtual/soft keyboard a plurality of data characters in a specific order of sequence contained in an array containing said plurality of data characters and
d. said first software program also assigns to each said data character contained in said array a defined sequential duration or period of elapsed time within said continued touch or press of said individual key and
e. said first software program measures the continuous time a user activates each of said individual keys by said continued touch or press of said individual key on said virtual/soft keyboard and
f. said first software program brings into focus on said display screen each of said data characters assigned to each of said individual keys based on its assigned specific order of sequence and its defined sequential duration of time or period within the total elapsed time said user continually touches or presses said individual key and
g. said first software program causes the insertion into said designated data input area of said display screen of the data character that is in focus at the time said continuous touch or press of said individual key is terminated by said user and if said user has not terminated said continuous touch or press of said individual key within the total elapsed time of all said data characters assigned to said individual key, said first software program will act in a rotary fashion and bring into focus on said display screen, said first data character defined in the specified set of data characters assigned to said individual key and will continue to rotor through said assigned data characters until the continuous touch or press of said individual key is terminated by said user, causing the insertion of said data character currently in focus to be inserted into said designated data input area of said display screen.

### CROSS-REFERENCE TO RELATED APPLICATION

The present application claims priority from U.S. provisional patent application No. 61/904,069 filed on Nov. 14, 2013, the entire content of which is incorporated herein by reference.

### FIELD OF INVENTION

The field of invention relates to virtual/soft keyboards in general and also touch sensitive virtual/soft keyboards which may be used on tablet computers, laptop computers, desktop computers, smart cell phones, PDAs, TV's, multimedia players, game consoles and any other electronic devices utilizing a virtual/soft keyboard for DATA input on a viewing screen of an electronic device.

### BACKGROUND

The advent of smart devices such as cell phones and tablet computer has driven the adoption of virtual/soft keyboards for the inputting of DATA such as letters, characters, numbers, strokes and symbols as well as text and navigation entries. Virtual/soft keyboards help to solve the issue with previous undersized keyboards typically found on smart phones, PDAs, such as the triple tap input of text on a cell phone dial pad where each key (1-0) could allow the user to enter different characters by rapidly pressing the same key more than once.

When smart phones and tablets devices began to appear, full keyboards began to be virtualized. These are also often referred to as soft keyboards. These keyboards are displayed on a portion of the display screen of the electronic device, generally at the bottom of the display screen. Typically a virtual/soft keyboard will display a QWERTY based keyboard design of a-z where an additional key has a “Shift” function which changes the appearance of the keyboard to all capital letters. If the user wants to enter a complete word in capitals they have to press the shift key prior to entering each letter in the word or engage a “Caps Lock” key, if supported by the device. Often, if the user wants to enter numbers and symbols they often must press another special key that gives them access to numbers and symbols on another layer of their virtual/soft keyboard. When they have finished entering the numbers and symbols from that secondary layer, they must often then press another special key to revert back to the lower case alpha library shown of the first layer of the virtual/soft keyboard.

Most virtual keyboards on smart phones and PDAs are very small, which can make them very difficult to view and use. This often contributes to misspelling of words, causing the user to manually correct the misspelling. Simply put, virtual/soft keyboards in use today are difficult for many users to use effectively.

### PROBLEM STATEMENT

What is needed is a method of simplifying and improving the DATA entry process on virtual/soft keyboards.

### SUMMARY

The shortcomings of current virtual/soft keyboard can be overcome by reducing the number of keys required and to eliminate the need to use a combination of keys to access capital letters and other special keys required to access letters, characters, numbers, strokes and symbols which are buried in the lower levels of display within the virtual/soft keyboards. In addition, due to the small screen size on many mobile devices, the use of the present invention allows fewer keys to be presented on the virtual keyboard, thus allowing each presented key to be larger and more easily used. This methodology will also enable users to save keystrokes by using the DATA assigned to said key more quickly, as it can be accessed by the continued touch/press of said key, which causes the DATA assigned to said key to come into focus in a rotary fashion.

### EMBODIMENTS

Reference will now be made in detail to various embodiments, examples of which are illustrated in the accompanying drawings. Wherever possible, the same reference numbers will be used throughout the drawings to refer to the same or like parts.

### DEFINITIONS

URL: A Universal Resource Locator which is an address where data or services are located. This is generally a network address such as a web site or a server storage address. A URL may be visually represented as a string of characters or a single ICON.
Continued press of said key: The measurement of elapsed time of the continued touch/press of said key
Termination of the touch/press of said key: The release by the user of the continued touch/press of said key.
Order of Sequence: The order of assignment of letters, characters, numbers, strokes, symbols, and URLs to said key in a hierarchical manner.
Viewing Screen of an Electronic Device: A display screen for presenting DATA from an electronic device to a user
Electronic Device: A device which contains a microprocessor and memory with computational skills
Virtual Keyboard: Can also be defined as a soft keyboard that is displayed on the viewing screen of an electronic device and is used for DATA entry.
Touch Sensitive Viewing Screen: A display device for presenting DATA from an electronic device to a user that is constructed to respond to touch directly to the surface of the display screen.
Non-Touch Sensitive Viewing Screen: A display screen for presenting DATA from an electronic device to a user that is NOT constructed to respond to touch directly to the surface of the display device.
Duration of Time: The elapsed time during which DATA assigned in sequence to that duration is in focus.
DATA: This represents the common and uncommon representations of letters, characters, numbers, strokes, symbols, and URLs used to communicate and can support multiple language sets as well as scientific notation.
DATA assigned to said key: This represents the letters, characters, numbers, strokes, symbols, and URLs that have been assigned from a plurality of arrays, for use by a individual key on the virtual/soft keyboard.
Rotary Effect: The circular repetition of DATA assigned to said key, once the total time duration assigned to said key has been completed and the touch/press of said key continues
Data Character: Any one of the letters, characters, numbers, strokes, symbols, or URLs defined in the above definitions.

### BRIEF DESCRIPTION OF THE DRAWINGS

FIG. 1 is a depiction of the theory of operations of an individual key using the technology which is covered by this disclosure to display and insert DATA assigned to said individual key.

FIG. 2 is a depiction of a screen overlay generated by the software program and which displays to the user the DATA that is in focus during each of the time durations made to said key.

FIG. 3 is a depiction of a screen overlay generated by the software program but in addition to the DATA in focus, the overlay also displays to the user the other DATA assigned to said key in the order of sequence in occupies within the continued key touch/press.

FIG. 4 is a depiction of the active DATA entry window shown on the viewing screen of the electronic device and the DATA in focus during each of the time durations made to said key.

FIG. 5 is a depiction of a typical key that can be displayed on the virtual/soft keyboard and the DATA assigned to said key in its order of sequence.

FIG. 6 is a depiction of the hardware and software components of the invention.

FIG. 7 is a depiction of an array containing all displayable data characters and virtual/soft keys for virtual/soft keys “1”, “2”, and “9” along with the arrays assigned to those virtual/soft keys.

FIGS. 8A-8F are depictions of arrays of data characters for virtual/soft key “1” and the array from which the software program with an index into the array selects or brings into focus one of the sequential data characters to be displayed.

FIG. 9 is a depiction of a logic diagram showing the logic flow of the invention.

FIGS. 10 and 11 are prior art drawings FIGS. 5 and 11 of U.S. patent application Ser. No. 12/791,542 published as US20110055697 A1.

FIG. 12 is a prior art drawing of U.S. patent application Ser. No. 12/802,665

### DETAILED DESCRIPTION OF THE INVENTION

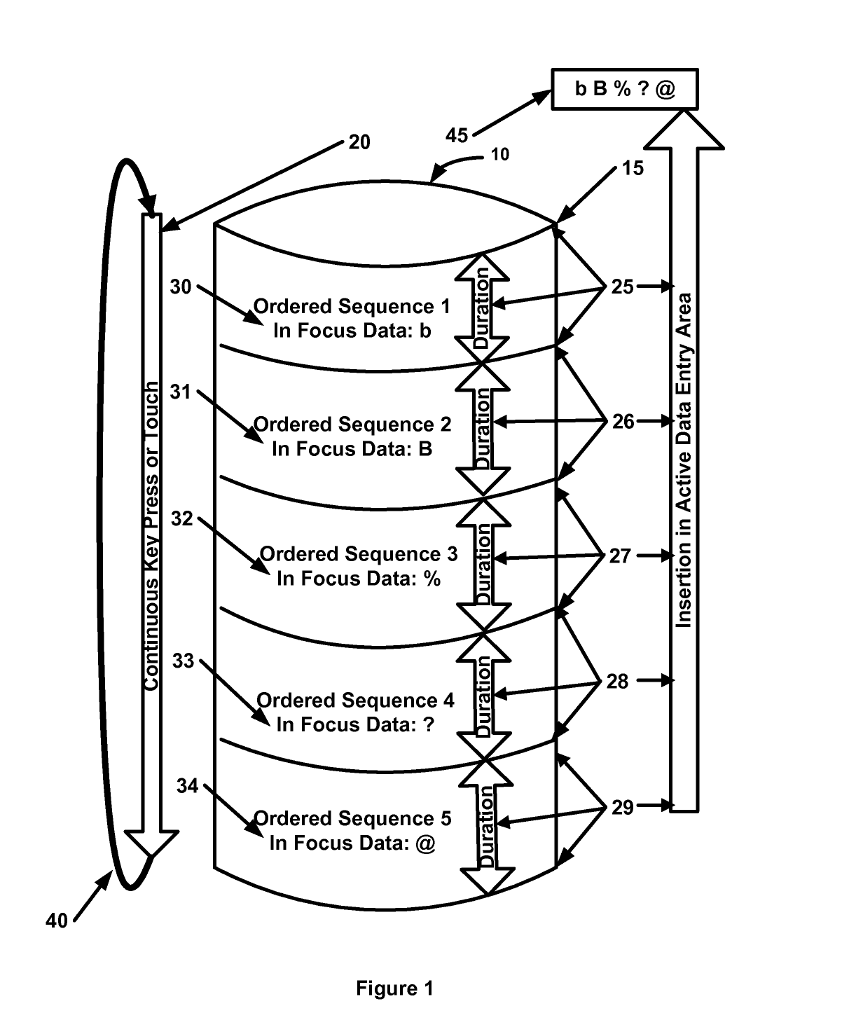

Now referencing FIG. 1 which depicts an example of the theory of operation for an individual key using this technology and in this example the 5 elements of DATA (b B % ? @) that are assigned to said key and the order of sequence to which they were also assigned. 10 depicts said key which may be contained in a virtual/soft keyboard and displayed on the viewing screen of an electronic device and configured to operate in the system and method defined by this disclosure. The software program within this disclosure assigns to said key a plurality of letters, characters, number, strokes or symbols and also defines the sequence of order in which they will be brought into focus. This is clearly depicted by 30, 31, 32, 33 and 34, which shows the DATA assigned to said key and their order of sequence to be brought into focus. Numbers 25, 26, 27, 28, 29 indicate the insertion 46 into the active data entry area 45 on the viewing screen, of the DATA assigned to that ordered sequence which is in focus when the continuous key touch/press is terminated. In this drawing 20 indicates the continuous press of said key 10. In the event that the continuous key touch/press exceeds the total combined value of durations assigned to said key 10, 40 indicates the rotary nature of the operation and the order of sequence is repeated until such time as the continuous touch/press of said key 10 is terminated and the DATA in focus is inserted into the active DATA entry area 45 on the viewing screen of the electronic device.

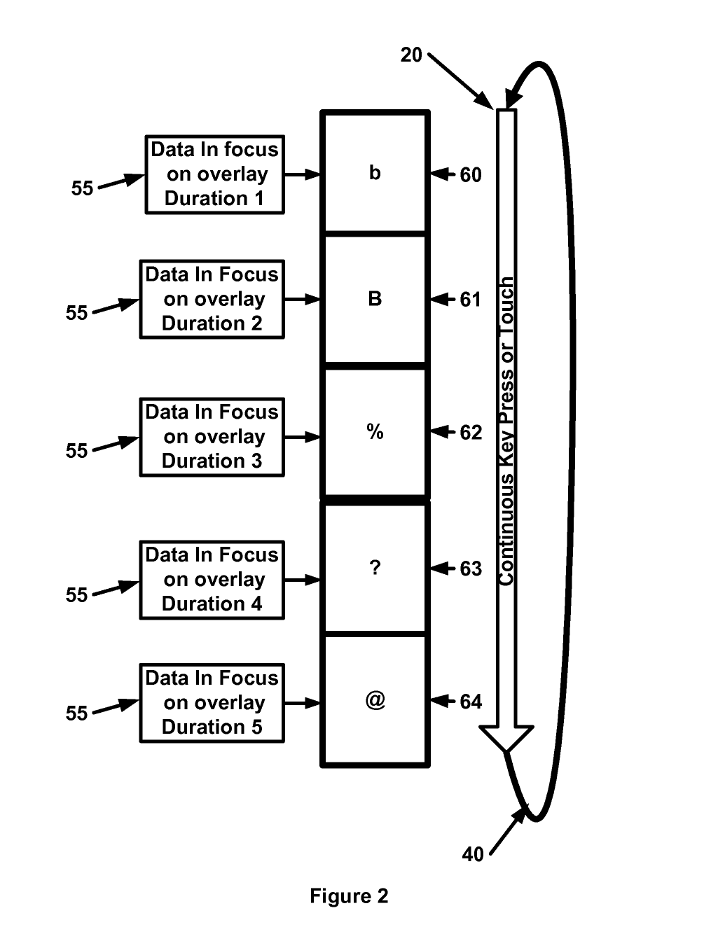

Now referencing FIG. 2 where 60, 61, 62, 63, 64 depict a screen overlay shown on the viewing screen of an electronic device which presents the DATA currently in focus 55 depending on the duration of time of the continued touch/press 20 of said key 10. In the event that the continuous key touch/press exceeds the total combined value of durations assigned to said key 10, 40 indicates the rotary nature of operation and the display of DATA in order of sequence on the screen overlay is repeated until such time as the continuous touch/press of said key 10 is terminated, at which time the screen overlay ceases to be shown on the viewing screen of the electronic device.

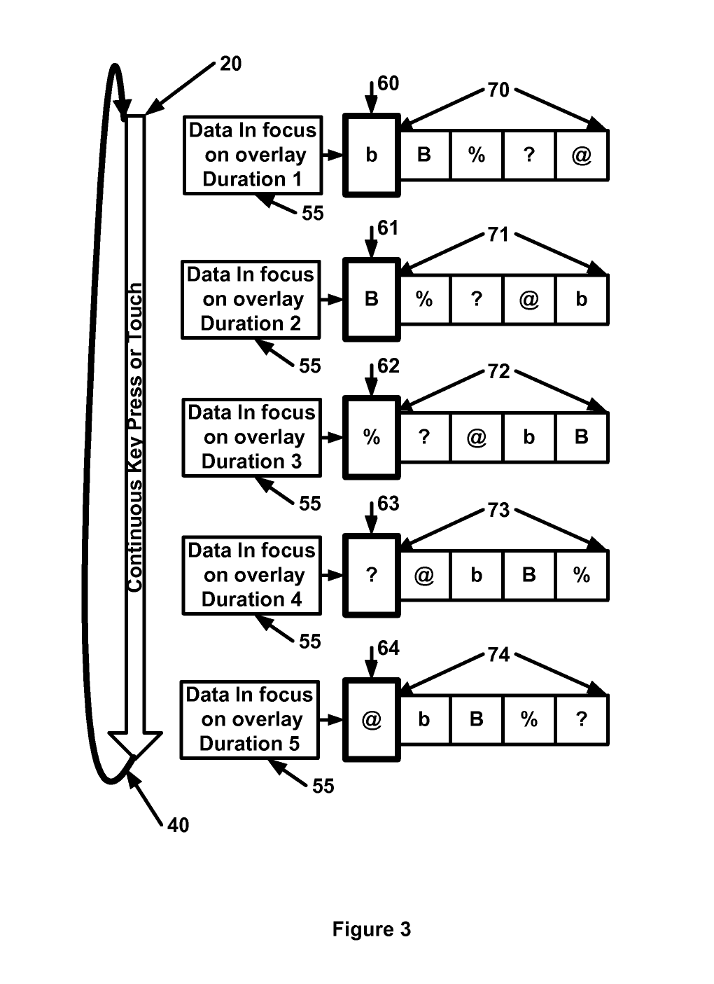

Now referencing FIG. 3 where 60, 61, 62, 63, 64 depict a screen overlay shown on the viewing screen of an electronic device which presents the DATA currently in focus 55 depending on the duration of time of the continued touch/press 20 of said key 10. References 70, 71, 72, 73, 74 depict the display on the screen overlay of the viewing screen of all DATA assigned to said key 10 and not currently in focus. As each of the time duration elapses, the next DATA element in the assigned sequence comes into focus and the current DATA in focus returns to the lowest level of sequence and is displayed as such on the screen overlay. In the event that the continuous key touch/press exceeds the total combined value of durations assigned to said key 10, 40 indicates the rotary nature of operation and the display of DATA in order of sequence on the screen overlay is repeated until such time as the continuous touch/press of said key is terminated, at which time the screen overlay ceases to be shown on the viewing screen of the electronic device.

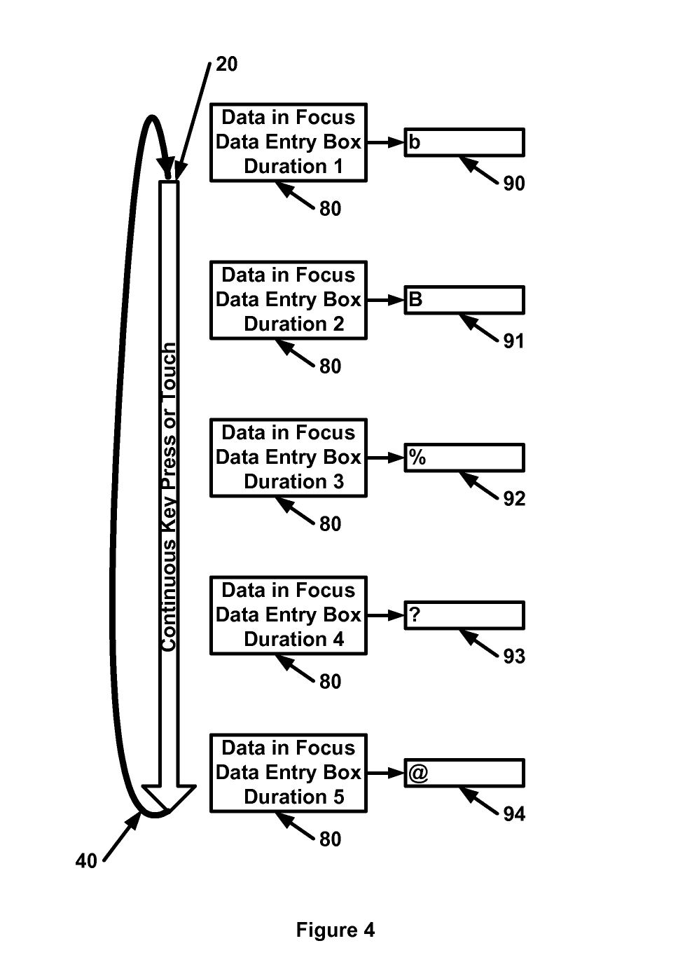

Now referencing FIG. 4 where 90, 91, 92, 93, 94 depict an active DATA entry area shown on the viewing screen of an electronic device which presents the DATA currently in focus 80 depending on the duration of time of the continued touch/press 20 of said key 10. In the event that the continuous key touch/press exceeds the total combined value of durations assigned to said key 10, 40 indicates the rotary nature of operation and the display of DATA in order of sequence in the active DATA entry area and is repeated until such time as the continuous touch/press of said key is terminated, at which time the DATA in focus is inserted into the active DATA entry area on the viewing screen of the electronic device.

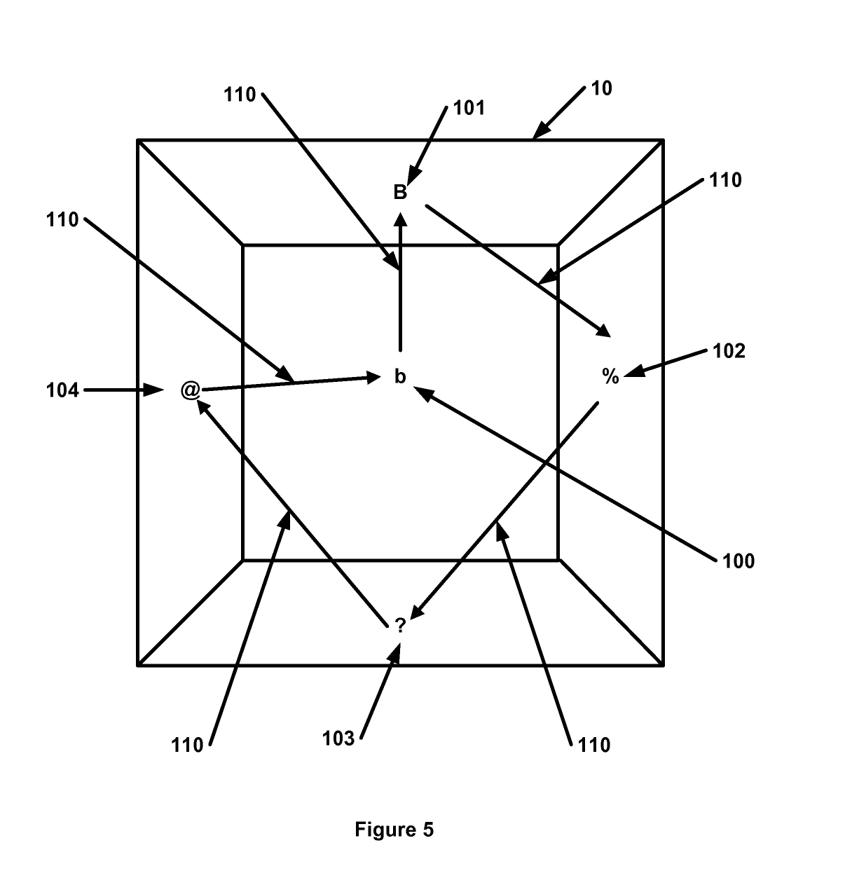

Now referencing FIG. 5 where 10 represents an example of a key described in this disclosure. On said key 10 are visual representations of the DATA 100, 101, 102, 103, 104 assigned to said key 10 as well as their assigned sequence of order 110. This visual representation is used to indicate to the user what keys are assigned to said key 10 and their order of sequence. This representation of order of sequence may use any visual notice to the user such as order.

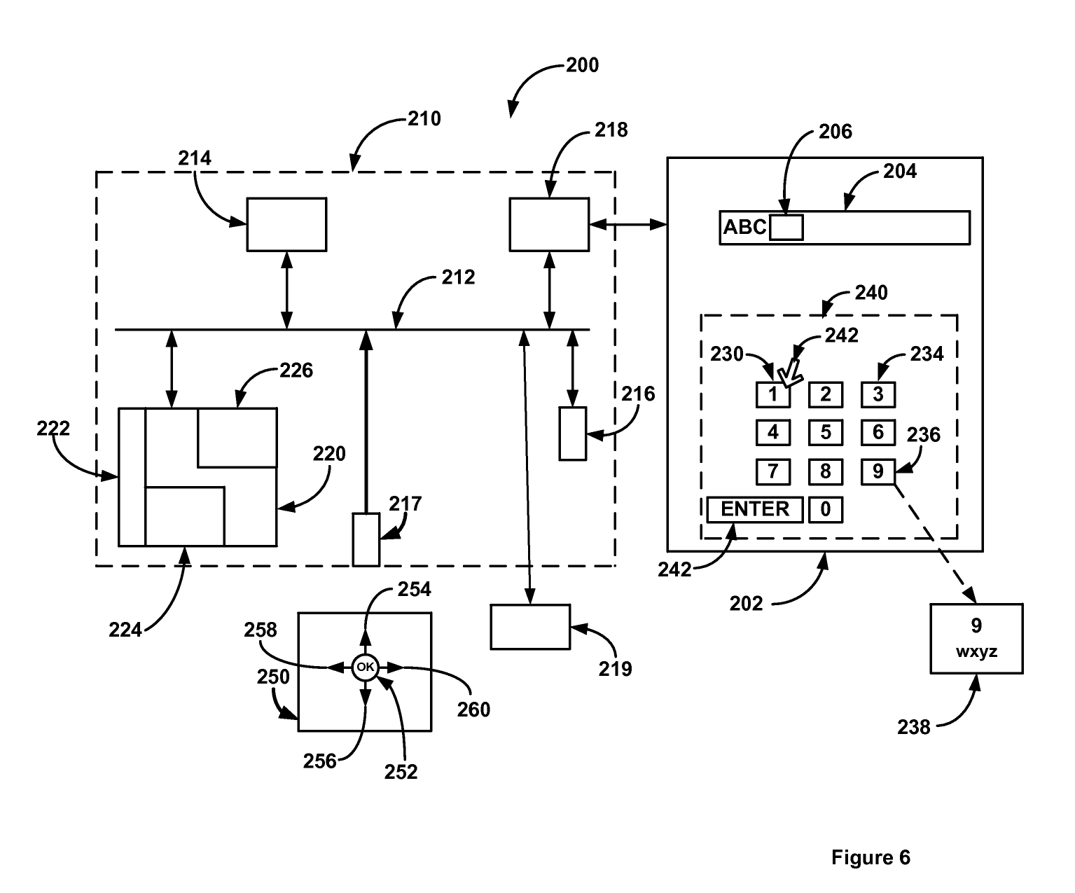

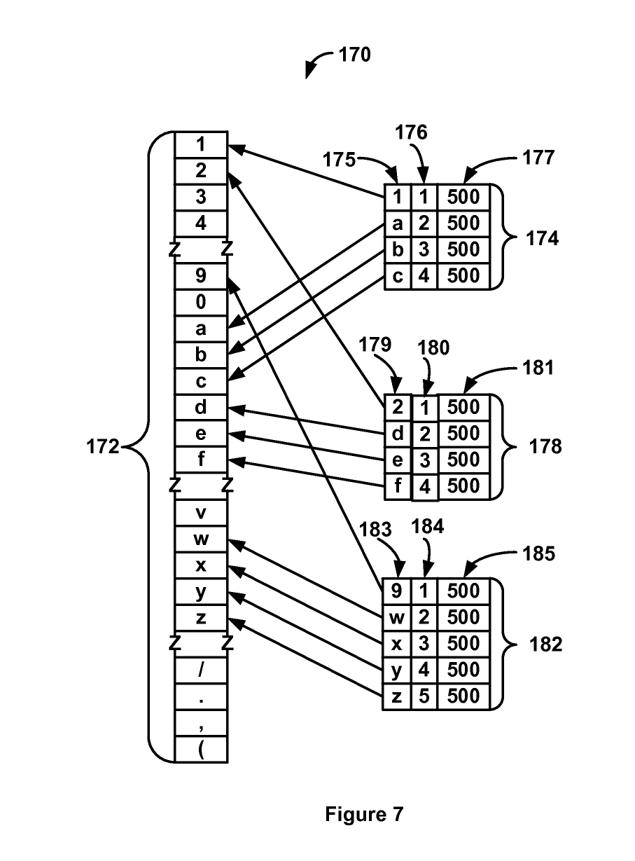

Now referencing FIG. 6 where 200 depicts a computing device with a touch sensitive display. In this depiction 210 is the hand held computing device with the hardware and software components necessary for implementing the invention. Hand held computing device 210 consists of CPU 214 which is connected to system bus 212. System bus 212 is a bi-directional bus that allows hardware components within computing device 210 to communicate with each other. System memory 220 contains software and storage for operating system 222, first software program 224, and buffer memory segment 226 which holds data character arrays 172, 174, 178, and 182 shown in FIG. 7. Data character array 172 contains displayable data characters. Data arrays 174, 178, and 182 contain indexes that point to specific data characters in data character array 172 or may contain the actual data character. Display and touch electronics interface 218 communicates with and controls touch sensitive display device 202. Touch sensitive display device 202 is shown with data input area 204 and current input character position 206 and soft/virtual keyboard 240.

Communications receiver 217 is a device which receives commands from remote controller 250. Remote controller 250 may communicate with communications receiver 217 via a RF link or an IR link. Remote controller 250 contains directional arrows up 254, down 256, left 258, and right 260 which can cause individual soft/virtual keys “1” through “0” to come into focus. First software program 224 will show the soft/virtual key that is in focus by highlighting the key or altering its appearance through bolding, or 3D effects by making the key to appear to be higher than adjacent soft/virtual keys. As the user manipulates arrow keys 254 through 260 on remote controller 250, the soft/virtual keys will, one at a time, come into focus. For example, if soft/virtual key “1” 230 is currently in focus and the user presses the right arrow key 260 twice, soft/virtual key “3” 234 will come into focus. After the user has, through use of the directional arrow buttons 254-260 on remote controller 250, brought the desired key into focus, he will press the OK button 252 which will cause the same action as if the user had touched his finger to the soft/virtual key currently in focus. Once the user stops touching OK button 252, the data character in focus as displayed in current input character position will remain in its current position and the empty square, current character position 206 will move to the next character position to receive the next character.

Glide point pad or touch pad 219 will, when the user touches pad 219 and begins moving his finger around on the pad cause cursor 242 to move and once cursor 242 hovers over a soft/virtual key such as soft/virtual key 230 the effect will be the same as if the user had touched soft/virtual key 230 with his finger. Once the user stops touching pad 219, the data character in focus as displayed in current input character position 206 will remain in its current position and the square will move to the next character position 206 to receive a character.

In operation, first software program 224 will display soft/virtual keyboard 240 with keys representing numerical digits 0-9. Soft/virtual keyboard 240 is intended to appear the same as that found on a telephone, cell phone, or ATM key pad. While the keys in depiction 240 only contain a single numeric character the keys may also display additional characters such as those found on some telephones where a large numeric character is displayed with smaller alpha characters positioned below depicted as 238. Data entry area 204 shows characters “abc” as the characters current residing in data entry area 204 and an empty square 206 which is the current input character position.

In this depiction, first software program 224 will send data characters pointed to in data character array 172 by the various key arrays (174, 178, and 182) from arrays resident in memory buffer 226 of memory 220 through system bus 212 and display and touch electronics interface 218 which in turn will display the characters on touch sensitive display device 202. When the user touches one of the soft/virtual keys displayed in soft/virtual keyboard 240, a signal will be sent from touch sensitive display device 202 to display and touch electronics interface 218 which in turn will send a signal to first software program 224 where the signal notifies first software program 224 of the coordinates of the touch on the surface of touch sensitive display device 202. Assume that the user touched soft/virtual key 230 (“1”). First software program 224 will then display the first data character pointed to by the index in array 174. At the time the first data character is displayed, first software program will start timer 216. The initial value placed into timer 216 is contained in column 177 of data character array 174 and in this depiction the timer value is expressed in milliseconds thus the time period for the first data character is 500 milliseconds or 0.5 seconds. The character will remain displayed in current input character position 206. If the user continues to press soft/virtual key 230 the timer will eventually expire and the next data character in data character 174, “a”, will over write the previous character in current input character position 206 and the time will be reset to the value associated with the second data character in data character array 174. This sequence of updating the data character displayed in current input character position 206 will continue until the last data character, “c” in data character array 174 is displayed after which the next character to be display will be the first data character in data character array 174. Display of the data characters from any of the data arrays will wrap around to the first data character in the data character array in a rotary fashion until the user lifts his finger from the soft/virtual key at which time the character being displayed will remain and the current input character position 206 will be moved to the next input position in data input area 204. In this depiction, pointing cursor 242 is controlled by a mouse (not shown), finger glide point device (not shown), or other types of cursor devices. In this depiction, a mouse, for example, can place a cursor 242 over the key 230 “1” and by pressing the activate button, left button on a windows™ mouse or the single button on an Apple™ mouse, and the soft/virtual key will activate and act the same as if the user's finger had pressed the soft/virtual key.

Now referencing FIG. 7 where 170 depicts a series of data character arrays. In this depiction, data character array 172 is a linear array containing displayable data characters. The data characters may be either 8 bit US-ASII data characters or UTF-8, UTF-16 and UTF-32 formats. In this depiction, data character arrays 174, 178, and 182 are arrays assigned to soft/virtual keys 230 (“1”), 234 (“a”), and 236 (‘9”). In actual practice, a data character array will be assigned to each soft/virtual key shown on soft/virtual keyboard 240. For this depiction only three keys are shown as having a data character array assigned. Each data character array, 167, 178, and 182, is composed of three columns where, using data character array 174 as an example, column 175 can contain a pointer to data character array 172 as in this depiction or it may contain the actual character from data character array 172. Note that an arrow, indicating a pointer is shown going from array cell 1,1 of data character array 174 to the first entry in data character array 172. Each position in column 175 contains a pointer to one character in data character array 172. Column 176 contains a sequence number which controls the order that the data characters are displayed in data input area 204 when the user presses a single key that displays the data characters. Column 177 contains a value in milliseconds that a given character will be display in current input character position 206. All for entries for column 177, in this depiction, are set to 500 or 500 milliseconds or 0.5 seconds. The columns for data character arrays 178 and 182 are formatted the same as data character array 174. Note that data character array 182 contains 5 rows of displayable characters, sequence numbers, and time periods while data character arrays 174 and 178 only contain 4 rows of data. Any soft/virtual key may contain any number of assigned data characters.

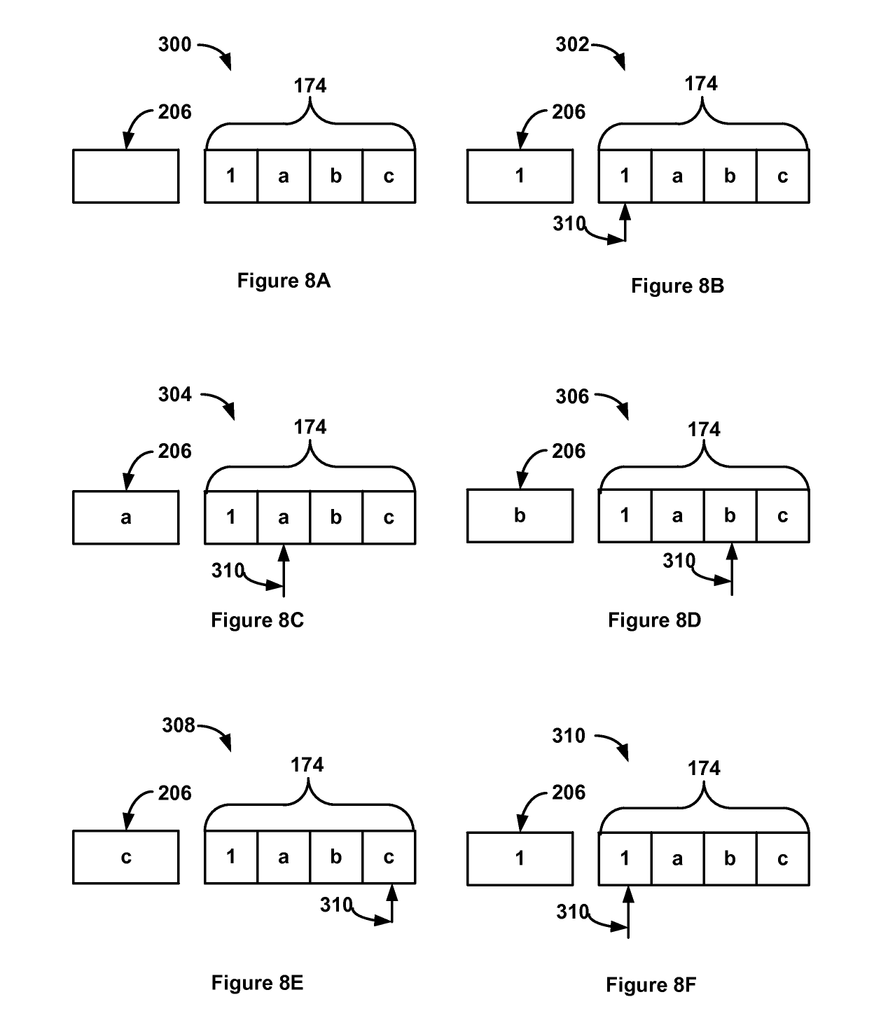

Now referencing FIGS. 8A through 8F. In these figures, data character array 174 is shown with the sequence of assigned data characters from data character array 172 as “1”, “a”, “b”, and “c”. Current input character position 206 is also shown in each of FIGS. 8A through 8F. Each of the FIGS. 8B through 8F also shows an index pointer indicating the current character to be displayed. The index pointer is identified as 310. When soft/virtual key 230 (“1”) is at rest, current input character position 206 is shown as a blank. If the user touches soft/virtual key 230, index pointer will point to the first cell in the array of data character array 174. Depiction 302 of FIG. 8B shows index pointer 310 pointing to the first cell which is a ‘1’ and that character is reflected in current input character position 206.

If the user continues to press soft/virtual key 230 the timer value associated with the data character element 1, shown as residing in column 177 of data character array 174 with a value of 500 milliseconds, will eventually expire and index pointer 310 will move to the second data character in the array depicted as 304 in FIG. 8C. In this depiction, the displayed character in current input character position 206 has changed to an “a” and the timer value will be reset to 500 milliseconds.

If the user continues to press soft/virtual key 230 the timer value associated with the data character element 2, shown as residing in column 177 of data character array 174 with a value of 500 milliseconds, will eventually expire and index pointer 310 will move to the third data character in the array depicted as 306 in FIG. 8D and the character reflected in current input character position 296 will change to “b”.

If the user continues to press soft/virtual key 230 the timer value associated with the data character element 3, shown as residing in column 177 of data character array 174 with a value of 500 milliseconds, will eventually expire and index pointer 310 will move to the forth data character in the array depicted as 308 in FIG. 8E and the character reflected in current input character position 206 will change to “c”.

If the user continues to press soft/virtual key 230 the timer value associated with the data character element 4, shown as residing in column 177 of data character array 174 with a value of 500 milliseconds, will eventually expire and index pointer 310 will move to the first data character in the array depicted as 310 in FIG. 8F and the character reflected in current input character position 206 will change to “1”.

Note how index pointer 310 moves from the first element of column 175 of data character array 174 to the last element of column 175 then wraps back around to the first element of column 175 if the user continues to press soft/virtual key 230. When the user lifts his finger from soft/virtual key 230, the data character being displayed in current input character position 206 will remain in current input character position 206 and the current input character position 206 will be moved to the next character position in input data area 204.

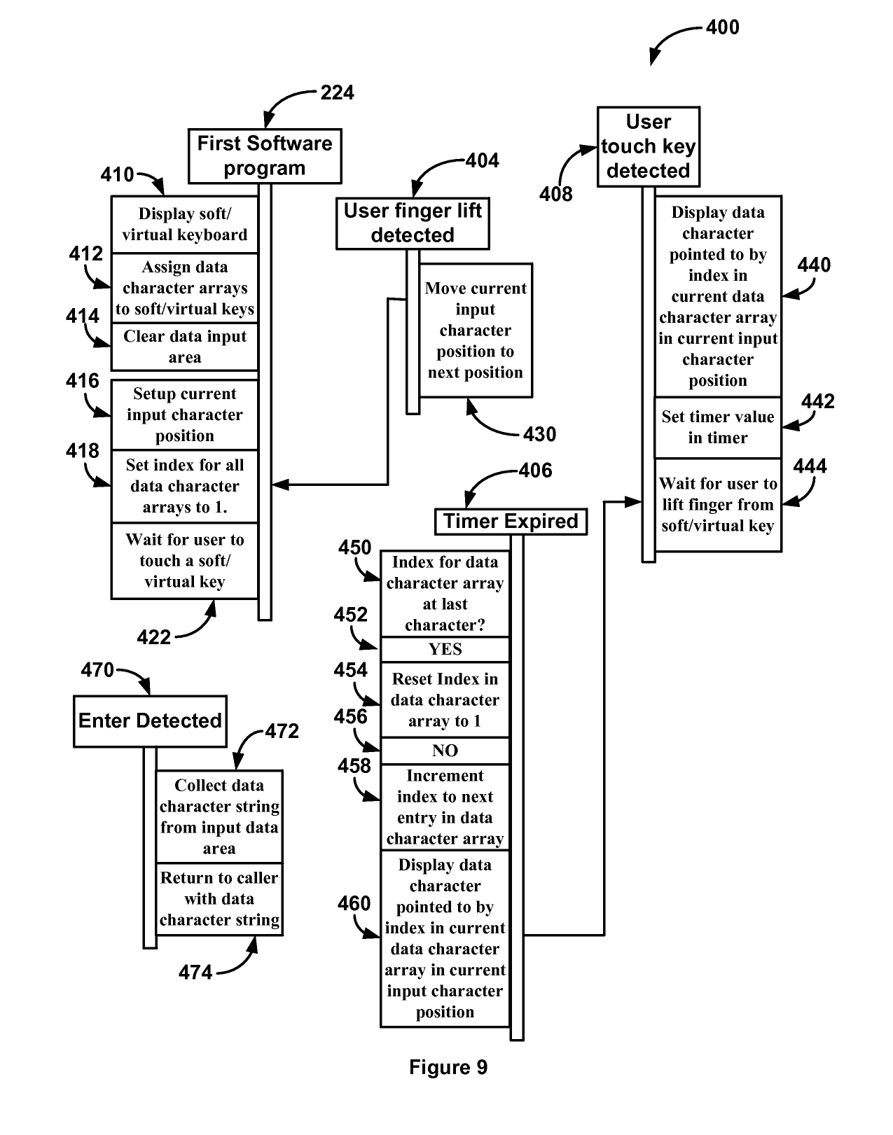

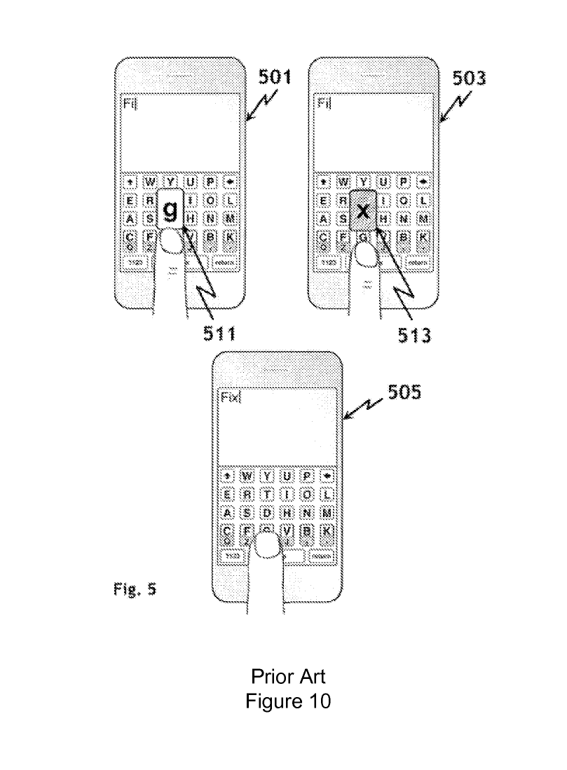

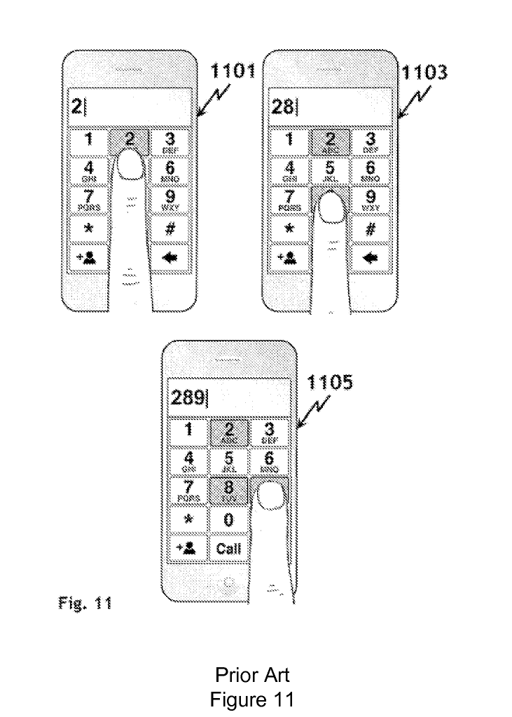

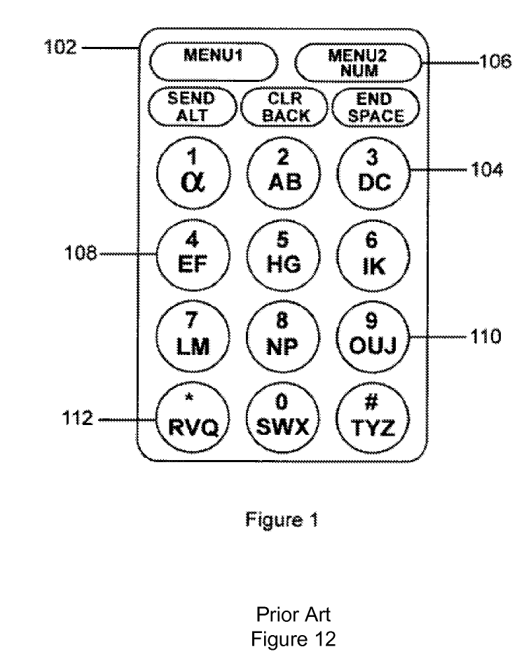

Now referencing FIG. 9 where 224 depicts a logic flow chart showing the steps of the invention. In this depiction first software program 224 includes subroutines 404 user finger lift detected, 408 user touch key detected, 406 timer expired, and 470 enter detected.

First software program 224 begins execution at display process block 410. This process block displays the images for the invention on touch sensitive display device 202. The images displayed will include data input area 204, current character input position 206, and soft/virtual keyboard 240 including the soft/virtual keys. After the images for the invention have been displayed, control will fall through to assign processing block 412 assign data characters to soft/virtual keys. This process block will allocate sufficient data character arrays as depicted in FIG. 7 with a data character array such as, for example, that depicted as data character array 174 in FIG. 7, assigned to each soft/virtual key. After the data character arrays have been allocated and initialized control will fall through to clear processing block 414 clear data input area. This processing block will clear data input area 204 after which control will fall through to setup processing block 416 setup current input character position. This processing block will set a visual cue or index pointer in data input area 204 which is where the first character to be entered will be positioned after which control will fall through to set index processing block 418 set index for all data character arrays to 1. This processing block setups an index for each of the data character arrays where the index is pointing to the first sequential data character to be displayed from the array when the user first touches one of the soft/virtual keys on the soft/virtual keyboard 240 after which control will fall through to wait processing block 422 wait for user to touch a soft/virtual key. This processing block puts first software program 224 into a wait state. Software program 224 will wake up when the user touches one of the soft/virtual keys on the soft/virtual keyboard 240.

User Touch Key Detected 408 is the first condition that can wake up first software program 244. When the user touches one of soft/virtual keys on the soft/virtual keyboard 240, this subroutine will execute starting at display processing block 440 display data character pointed to by index in current data character array in current input character position. This processing block will display the first character from the data character array assigned to the soft/virtual key the user touched after which control will fall through to set timer processing block 442. This processing block will set a value in timer 216. The value is taken from, for example, if the soft/virtual key was 230 (‘1’), then the value placed in timer 216 will be taken from column 177 first row. In this example, that value will be 500 milliseconds. After the timer is set, control will fall through to wait processing block 444. This processing block will place first software program 224 into a wait state. The next event that wakes up first software program 224 will be the detection of the user lifting his finger off of the soft/virtual key he had first touched or timer 216 expiring.

User finger lift detected 404 is a subroutine executed when the user stops touching the soft/virtual key he had previous touched. This subroutine begins execution at move processing block 430 move current input character position to next position. This processing block moves the index and/or the visual cue or index pointer in data input area 204 where the next character to be entered will be positioned after which control will be transferred to set index processing block 418 set index for all data character arrays to 1. This processing block initializes the index pointers to the first data character in each of the data character arrays after which control will fall through to wait processing block 422 wait for user to touch a soft/virtual key. This processing block puts first software program 224 into a wait state. Software program 224 will next wake up when the user touches one of the soft/virtual keys on the soft/virtual keyboard 240.

Timer expired 406 is a subroutine executed when timer 216 has expired because the current character being displayed in current input character position 206. The subroutine begins execution at decision processing block 450 index for data character array at last character? This processing block determines if the current data character in the current data character array assigned to the soft/virtual key being displayed in current input character position 206 is the last sequential character in the array. If the data character being displayed in current input character position 206 is the last sequential data character in the soft/virtual data character array assigned to the soft/virtual key being pressed is the last data character in the array control will be transferred to results processing block 452 YES after which control will be transferred to reset processing block 454 reset index in data character array to 1. This processing block will reset the index for the data character array from the last data character in the data character array to the first data character in the data character array which has the effect of wrapping the array after which control will be transferred to display processing block 460 display data character pointed to by index in current data character array in current input character position. If decision processing block 450 determined that the index for the current data character in the data character array was not the last data character in the data character array control will be transferred to results processing block 456 NO after which control will be transferred to increment processing block 458 increment index to next entry in data character array. This processing block increments the index in the data character array to the next sequential data character after which control is transferred to display processing block 460 display data character pointed to by index in current data character array in current input character position 206. This processing block overwrites the new data character from the current data character array onto the old data character in the current input character position 206 then resets timer 216 with the value associated with the new data character after which control will be transferred to wait processing block 444 wait for user to lift finger from soft/virtual key. This processing block will place first software program 224 into a wait state. The next event that wakes up first software program 224 will be the detection of the user lifting his finger off of the soft/virtual key he had first touched or timer 216 expiring.

Subroutine 470 enter detected will be executed when the user touches soft/virtual key 240 enter. This subroutine will begin execution at collect processing block 472 collect data character string from input data area. This processing block will pull the data characters from data input area 204 and package them into a string suitable for returning to the caller after which control will fall through to return processing block 474 return to caller with data character string. Exiting of this subroutine to the calling program will result in the just entered sequence of data characters being passed to the caller.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other techniques of synchronization can be used. For example while FIG. 7 shows file closing events and file deleting events causing the file to be changed on the duplicate partition, this can be done at time intervals instead.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification. Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A system for use on a hand held computing device where a virtual/soft keyboard is presented on a display screen of said hand held computing device, where selected individual keys displayed within said virtual/soft keyboard have the ability to display any of a plurality of data characters assigned to each of said individual keys and select and insert into a designated data input area on said display screen where each said data character is displayed for a portion of a time duration of a user's continuous touch or press on said individual key and comprising:
a. a display screen on said hand held computing device,
b. a first software program that displays said virtual/soft keyboard on the display screen of said hand held computing device whereby,
c. said first software program assigns to each said individual key on said virtual/soft keyboard a plurality of data characters in a specific order of sequence contained in an array containing said plurality of data characters and
d. said first software program also assigns to each said data character contained in said array a defined sequential duration or period of elapsed time within said continued touch or press of said individual key and
e. said first software program measures the continuous time a user activates each of said individual keys by said continued touch or press of said individual key on said virtual/soft keyboard and
f. said first software program brings into focus on said display screen each of said data characters assigned to each of said individual keys based on its assigned specific order of sequence and its defined sequential duration of time or period within the total elapsed time said user continually touches or presses said individual key and
g. said first software program causes the insertion into said designated data input area of said display screen of the data character that is in focus at the time said continuous touch or press of said individual key is terminated by said user and if said user has not terminated said continuous touch or press of said individual key within the total elapsed time of all said data characters assigned to said individual key, said first software program will act in a rotary fashion and bring into focus on said display screen, said first data character defined in the specified set of data characters assigned to said individual key and will continue to rotor through said assigned data characters until the continuous touch or press of said individual key is terminated by said user, causing the insertion of said data character currently in focus to be inserted into said designated data input area of said display screen.

2. The system of claim 1 whereby said data character assigned to any of said individual keys is assigned by said first software program, a duration of elapsed time within said continued touch or press of said individual key and said duration of elapsed time of said continued touch or press brings into focus on said display screen of said hand held computing device, the said data character assigned to that period of elapsed time and in the specific order of sequence in which they were assigned to said individual key.

3. The system of claim 1 whereby the selection of a data character assigned by said first software program to said individual key and presented on said virtual/soft keyboard and displayed on said display screen of said hand held computing device is determined by the elapsed time of said continued touch or press of said individual key by:
a. A finger or stylus or any other detectable object directly touching said individual key displayed within said virtual/soft keyboard presented on a touch-sensitive viewing screen of said hand held computing device;
b. a button on a pointing device such as a mouse, remote control or any other device that places an on-screen cursor over said individual key displayed on said virtual/soft keyboard on said viewing screen of said hand held computing device;
c. a touch sensitive surface on a pointing device such as a mouse, glide point device, remote control, touch pad or any other device that places an on-screen cursor over said individual key displayed on said virtual/soft keyboard on said viewing screen of the hand held computing device.

4. The system of claim 3 whereby said display screen that displays said virtual/soft keyboard may be:
a. a touch sensitive display device or,
b. a non touch-sensitive display device where pointer devices such as a mouse, hand held remote control device, or touch-pad is used to access each of said individual keys on said virtual/soft keyboard.

5. The system of claim 1 whereby the assignment by said first software program of said data characters contained in said arrays may be user definable for each said individual key.

6. The system of claim 1 whereby the data characters assigned from said arrays to said individual keys by said first software program may be visually displayed on each of said individual keys of said virtual/soft keyboard in a manner which denotes to the user the specific order of sequence in which they were assigned to each of said individual keys and representation of said data characters may be based on the position on said individual keys or any other visual representation or overlay that indicates to said user the specific order of sequence associated with each of said data characters.

7. A method controlled by a first software program executing on a hand held computing device and displaying in a designated data entry area on a display screen coupled to said hand held computing device, one of a plurality of data characters assigned to an individual key on a virtual/soft keyboard comprising:
a. displaying said individual key on said virtual/soft keyboard on said display device of a hand held computing device and
b. assigning said individual keys on said virtual/soft keyboard a plurality of data characters in a specific order of sequence for each of said keys from a plurality of arrays each containing a plurality of data characters and
c. assigning to each said data character assigned to each said individual key a defined sequential duration or period of elapsed time within a continued touch or press of said individual key by a user and,
d. said first software program measuring with a timer, the continuous time said user activates each of said individual keys by said continued touch or press of each of said individual keys on said virtual/soft keyboard and
e. bringing into focus on said display device said data character assigned to said individual key based on its assigned specific order of sequence to be displayed and its assigned sequential duration of time within the total elapsed time said user continually touched or pressed each of said individual keys and
f. inserting into said designated data entry area on said display screen of said data character that is in focus at the time the continuous touch or key press is terminated by said user and
g. if said user has not terminated the continuous touch or press of said individual key within the total elapsed time of all said data characters assigned to said individual key , said first software program will act in a rotary fashion and bring into focus on said display device, said first data character defined in said specified set of data characters assigned to said individual key and will continue to rotor through the said assigned data characters until said continuous touch or press of said individual key is terminated by said user, causing the insertion of said data character currently in focus to be inserted into said designated data entry area of said display device.

8. The method of claim 7 whereby each data character assigned to said individual key within said virtual/soft keyboard is assigned a sequence and duration of time within said continued touch or press of each of said individual keys and said duration of time of said continued touch or press determines the selection of focus of the data character assigned to said individual key.

9. The method of claim 7 whereby said display device that displays said soft keyboard may be:
a. a touch sensitive display device or,
b. a non touch-sensitive display device where a pointer device such as a mouse, hand held remote control device or touch-pad is used to press said individual key.

10. The method of claim 9 whereby the focus of a data character assigned to said individual key on said virtual/soft keyboard on a touch sensitive display device is determined by the time duration of said continued touch or press of said key by:
a. a finger directly to said key on a touch sensitive display device,
b. a stylus directly to said key on a touch sensitive display device
c. A remote control device, such as a TV remote, which is used for selection on said virtual/soft keyboard displayed on said display device of said hand held computing device.

11. The method of claim 9 whereby the focus of said data character assigned to said individual key on said virtual/soft keyboard on said non-touch sensitive display device is determined by the time duration of said continued touch or press of said key by:
a. a pointer device such as a mouse, hand held remote control device or touch-pad that places a cursor over said key.

12. The method of claim 7 whereby the data characters assigned to said individual keys are visually displayed on said individual keys of said virtual/soft keyboard.

13. The method of claim 12 whereby said data characters assigned to said individual keys may be visually displayed on said individual keys of said virtual/soft keyboard in a manner which denotes to said user the specific order of sequence in which they are assigned to said individual keys and the order of sequence may be represented to the user by:
a: the position on each of said individual keys to denote the specific order of sequence and,
b: any other visual representation or screen overlay that indicates to said user the specific order of sequence associated with that said data character assigned to said individual key.

14. The method of claim 7 whereby each of said data characters assigned to each of said individual keys may be visually displayed on said individual key of said virtual/soft keyboard in a random manner.

15. The method of claim 7 whereby the data character that has been brought into focus during said continued touch or press of said individual key is displayed to said user in the active data entry area shown on said display device of said hand held computing device.

16. The method of claim 15 whereby the active data entry area shown on said display device of said hand held computing device can, in addition to displaying said data character that is in focus on said individual key, also display in said active data entry area, a plurality of other said data characters that are assigned to other said individual keys.

17. The method of claim 7 whereby the said data character that has been brought into focus during said continued touch or press of said individual key is displayed to the user in a screen overlay shown on said display device of said display screen.

18. The method of claim 17 whereby the screen overlay shown on said display screen of said hand held computing device can, in addition to displaying said data character that is in focus on said individual key being pressed, also display on said screen overlay a plurality of the other said data characters that are assigned to said individual key.
